(19) United States
(12) Patent Application Publication
(10) Pub. No.: US 2018/0100207 A1
(43) Pub. Date: Apr. 12, 2018

(54) CONVERTER

(71) Applicant: SMS Group GmbH, 40237 Düsseldorf (DE)

(72) Inventor: RALF NÖRTHEMANN, Sprockhövel (DE)

(73) Assignee: SMS Group GmbH, 40237 Düsseldorf (DE)

(21) Appl. No.: 15/565,077

(22) PCT Filed: Apr. 1, 2016
(86) PCT No.: PCT/DE2016/100155

§ 371 Date: Oct. 6, 2017

(30) Foreign Application Priority Data
Apr. 8, 2015 (DE) 10 2015 105 307.1

(51) Int. Cl. C21C 5/46; C21C 5/32; F27D 3/16

(52) U.S. Cl. CPC C21C 5/4606; C21C 5/32; F27D 2003/165; F27D 2003/164; F27D 3/16

(57) ABSTRACT

A converter for the production of steel by a blowing process from a substantially liquid raw material, in particular pig iron, includes several injectors which are dispersed in the sidewall of the converter about the converter inner circumference and directed towards the bath level for refining the pig iron. The injectors are designed as supersonic nozzle, which are surrounded by a ring nozzle forming an enveloping gas jet. The injectors are oriented at an angle of max. 43° in relation to the bath surface, with oxygen being introduced through the supersonic nozzle and a mixture of compressed air and natural gas being introduced through the ring nozzle. The jet pulse for the oxygen jet fed through the supersonic nozzle is dimensioned such that an infiltration of the oxygen jet into the melt bath is ensured.

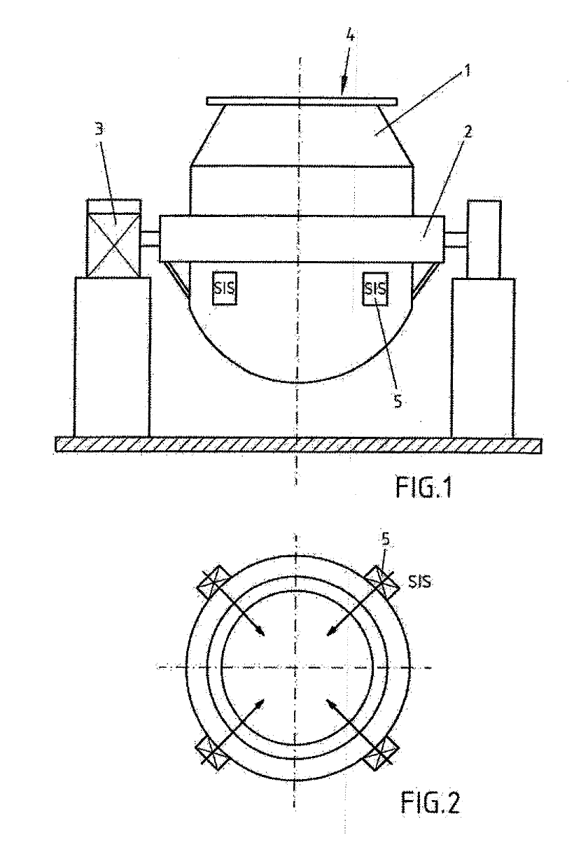

The invention relates to a converter for the production of steel.

In the production of steel in the electric arc furnace, referred to as EAF for short, in which primary solids are used, it is known to use additional natural gas burners during the melting phase for scrap. This contributes to considerably reduce the demand for electrical energy.

For some time, so-called SIS units (SMS=Siemag Injection Systems) find application.

This involves so-called injector—burner combinations for burning, introduction of oxygen and possibly for blowing carbon through the sidewalls of the EAF.

The injectors are operated in two modes: that is the burner mode and the injector mode.

In the burner mode, a powerful flame assists in the melting of scrap in the relatively cold regions of the furnace, i.e. essentially outside the furnace center. During melting, that is in the so-called flat bath phase, the burners are switched over into the injector mode.

For this purpose, a concentrated oxygen jet is blown into the furnace at supersonic speed, thereby establishing between oxygen and melt an optimal interaction which is critical for the rapid decarburization of the steel.

The production of steel in the converter when operated in the BOF (Basic Oxygen Furnace) or AOD (Argon Oxygen Decarburization) is different.

To date, oxygen blowing lances are used in converters for introducing oxygen into the bath. These lances are located above the converter and are then moved from above into the pear-shaped interior space.

When using oxygen lances, the provision of an enormous installation height above the converter is required. This incurs high investment costs when newly constructing the steel mill shop.

The invention is based on the object to lower in particular the investment costs for converter steel mills.

This object is attained according to the invention by a converter for the production of steel by the blowing process from a substantially liquid raw material, in particular pig iron, which is characterized in
that for refining the pig iron, instead of an oxygen lance which can be introduced through the upper converter opening and bottom nozzles which are arranged in the bottom of the converter, provision is made for several injectors which are dispersed in the sidewall of the converter about the converter inner circumference and directed towards the bath level,
that the injectors are designed as supersonic nozzle, which are surrounded by a ring nozzle forming an enveloping gas jet,
that the injectors are oriented at an angle of max. 43° in relation to the bath surface,
that oxygen can be introduced through the supersonic nozzle and a mixture of compressed air and natural gas can be introduced through the ring nozzle, and
that the jet pulse for the oxygen jet fed through the supersonic nozzle is dimensioned such that an infiltration of the oxygen jet into the melt bath is ensured.

Preferably, the injectors are switchable to a burner mode with long flame and to an injector mode with concentrated oxygen jet and high impact pulse.

The advantages resulting from this converter design and from the type of operation reside in that the converter can be installed in all steel mill shops with comparatively low overall structural height.

This also offers the possibility to convert EAF steel mills into BOF facilities.

The investment volume of the lance is also very high compared to the sidewall injection with SIS injectors.

These advantages are of particular importance for producer countries, where DRI and HBI are scarcely available at least temporarily and therefore increasingly focus on the raw material pig iron from the blast furnace. The EAF halls are low. Precisely for this application, the use of the SIS converter is also of interest, when the blowing lance is eliminated, because when using large quantities of pig iron, the converter is in fact the better aggregate.

In principle, the arrangement according to the invention can also be used in addition to the use of an oxygen lance and bottom nozzles in order to take benefit of their advantages.

The invention shall be explained hereinafter with reference to the drawing.

The drawing shows schematically the side view and the cross section of a converter.

In a known manner, the pear-shaped converter vessel 1—held by a retaining ring 2—is laterally supported, with a tilting drive 3 being integrated into the lateral support. Normally, an oxygen lance—not shown here—is introduced through the upper opening 4 of the converter, through which oxygen lance oxygen required for refining the raw iron melt is introduced.

According to the invention, this type of introduction of oxygen is now replaced by injectors 5 which are mounted in the sidewall of the converter vessel and dispersed about the circumference, and through which the required oxygen can be introduced into the interior of the converter—above the bath level.

What is claimed is:

1.-6. (canceled)

7. A converter for the production of steel by a blowing process from a substantially liquid raw material, said converter comprising:
a vessel having a sidewall;
a plurality of injectors dispersed in the sidewall about an inner circumference of the vessel and directed towards a bath level of a melt bath for refining the raw material, said injectors being embodied as supersonic Laval nozzle and oriented at an angle of max. 43° in relation to a bath surface for introducing an oxygen jet of oxygen into an interior of the vessel at supersonic speed which is greater than 1.5× the sound of speed, with a jet pulse for the oxygen jet fed through the supersonic nozzle being dimensioned such that an infiltration of the oxygen jet into the melt bath is ensured; and
a ring nozzle surrounding the injectors and forming an enveloping gas jet, said ring nozzle being constructed to introduce a mixture of compressed air and natural gas into the interior of the vessel.

8. The converter of claim 7, wherein the raw material is pig iron.

9. The converter of claim 7, wherein the injectors are configured for a switching over to a burner mode with long flame and an injector mode with a concentrated oxygen jet and high impact impulse.

10. The converter of claim 7, wherein the injectors have an installation height which is up to a maximum of approximately 2 m above the bath surface.

11. The converter of claim 7, wherein the injectors are additionally used for application of an oxygen lance and bottom nozzles.
